(19) United States
(12) Patent Application Publication
(10) Pub. No.: US 2023/0117913 A1
(43) Pub. Date: Apr. 20, 2023

(54) FIELD COIL FOR A STATIONARY PLASMA THRUSTER

(71) Applicant: SAFRAN AIRCRAFT ENGINES, Paris (FR)

(72) Inventors: Julien Pierre Alain VAUDOLON, Vernon (FR); Laurent Alexandre Rene GODARD, Moissy-Cramayel (FR)

(21) Appl. No.: 17/906,909

(22) PCT Filed: Mar. 24, 2021
(86) PCT No.: PCT/FR2021/050509

§ 371 Date: Sep. 21, 2022

(30) Foreign Application Priority Data
Mar. 24, 2020 (FR) 2002881

(51) Int. Cl. H01F 27/32; H01F 27/28; H01F 41/12

(52) U.S. Cl. CPC H01F 27/323; H01F 27/2828; H01F 41/127

(57) ABSTRACT

The invention relates to a field coil (18, 20), in particular for a satellite hall-effect plasma thruster, said field coil (18, 20) comprising a core (22) on which a conductor (24) is wound, characterized in that the conductor comprises an inorganic insulation cable (26) impregnated with a high-temperature-resistant silicone coating (32).

### TECHNICAL FIELD OF THE INVENTION

The invention relates to an inductor winding, in particular for a plasma satellite motor operating according to the hall-effect.

### TECHNICAL BACKGROUND

The recent developments in space propulsion are leading to the increasing use of hall-effect thrusters, also referred to as stationary plasma motors for the motorization of satellites, for example for low earth orbit operations.

A stationary plasma motor is a type of plasma thrusters that uses an electric field to accelerate ions. It is referred to as a hall-effect because it uses a magnetic field to trap the electrons that serve to ionise a gas. The ions are then accelerated and produce a thrust. The gases used can be of different types. Xenon is the most commonly used gas but it is also possible to use Krypton, Bismuth, Argon, Iodine, Magnesium, and Zinc.

Such a motor is capable of accelerating the gases to a speed of between 10 km/s and 80 km/s, for pulses of the order of a few thousand seconds. The thrust that can be produced by such a motor varies according to the electrical power provided to it.

The applications of such motors are mainly the control of the orientation and position of the satellites in earth orbit, and also for the main motorization of medium-sized space robots.

The stationary plasma motors require the generation of a magnetic field. This is done using coils or inductor windings. Such coils are subject to a harsh environment, particularly due to the presence of micrometeorites in the environment in which the satellite operates. These micrometeorites can damage the insulation of the wires of the coils and consequently short-circuit the windings, thereby reducing the number of turns and altering the magnetic field produced by the coils. In addition, these coils are subject to high temperatures and it is necessary to protect them from any exaggerated rise in temperature. Such a motor is described for example in the document JP-2007.257842-A.

It is therefore necessary to take particular care in the manufacture of these coils and to use conductors comprising a reinforced insulation for producing the windings.

The wires used are usually inorganic insulation cables, with the insulation made of a ceramic material. However, this ceramic material is relatively fragile and needs an additional protection.

Such wires coated with an additional coating are disclosed in the documents US-5.636.434-A1, US-2017/0011820, US-9.508.461-B2. However, they have not been applied to the manufacture of stationary plasma motor windings, with the constraints that this implies.

### SUMMARY OF THE INVENTION

The invention proposes to provide this protection by carrying out an impregnation of the cable used to produce the inductor windings with a high-temperature resistant silicone coating.

For this purpose, the invention proposes an inductor winding, in particular for a plasma satellite motor operating according to the hall-effect, this inductor winding comprising a nucleus on which a conductor is wound, characterised in that this conductor comprises an inorganic insulation cable impregnated with a silicone coating resistant to high temperatures up to 593° C.

According to other characteristics of the winding:
the inorganic insulation cable comprises a rigid core made of copper-nickel alloy covered by a ceramic insulator,
the silicone coating is suitable for use at temperatures between -70° C. and 400° C., is electrically insulating, has a drying temperature below 300° C., a thermal conductivity above 1W/m/°C and a coefficient of thermal expansion above 5 x 10⁻⁶/K.
the nucleus has a radius of curvature greater than or equal to five times the diameter of the inorganic insulation cable.

The invention also relates to a tooling for the manufacture of an inductor winding of the type described above, characterised in that it comprises:
a reel receiving a coil of the inorganic insulation cable;
an impregnation tray, receiving the silicone compound dissolved in a solvent, through which said inorganic insulation cable passes, and comprising at least one caster internal to the tray configured to ensure the guidance of said inorganic insulation cable as it passes through said tray, and at least one sponge positioned at an outlet of said tray through which the cable passes to mop up said cable,
a nucleus of the winding, mounted in rotation, and intended to receive in winding the cable impregnated with silicone compound.

According to another characteristic of the tooling, a path of said cable in said tooling between the reel and the nucleus has radii of curvature which are greater than or equal to five times a diameter of the inorganic insulation cable, and which do not reverse between the reel and the nucleus.

The invention also relates to a method for manufacturing an inductor winding using a tooling of the type described above, characterised in that it comprises at least:
a first step of providing a nucleus of the winding and placing said nucleus in said tooling;
a second step during which said inorganic insulation cable is impregnated with said silicone compound and wound onto the nucleus, the silicone coating being deposited when the cable is soaked in the silicone compound dissolved in a solvent and then by evaporation of said solvent,
a third step during which the winding consisting of the nucleus equipped with the impregnated cable is left to dry at room temperature for several days,
a fourth step of baking the winding in an oven, said baking comprising a gradual rise in temperature to a baking temperature starting at room temperature.

The invention also relates to a method for manufacturing an alternative inductor winding, characterised in that it comprises at least:
a first step of providing a nucleus of the winding,
a second step during which the winding is produced by winding said inorganic insulation cable onto the nucleus,
a third step during which said winding is immersed in a bath of silicone compound dissolved in a solvent, the silicone coating being deposited when the winding is soaked in the silicone compound dissolved in a solvent and then by evaporating said solvent,
a fourth step during which the winding is left to dry at room temperature for several days,
a fifth step of baking the winding in an oven, said baking comprising a gradual rise in temperature to a baking temperature starting from room temperature.

The invention is applicable to a plasma satellite motor operating according to the hall-effect and comprising at least one inductor winding of the type described above.

### BRIEF DESCRIPTION OF THE FIGURES

Further characteristics and advantages of the invention will become apparent from the following detailed description, for the understanding of which reference is made to the attached drawings in which:

FIG. 1 is a perspective view of an inorganic insulation cable used for the manufacture of a conductor of a winding according to the invention;

FIG. 2 is a cross-sectional view of a conductor according to the invention;

FIG. 3 is a schematic cross-sectional view of a satellite motor comprising a winding according to the invention;

FIG. 4 is a perspective view of a winding according to the invention;

FIG. 5 is an overall perspective view of a tooling for the manufacture of the winding according to the invention;

FIG. 6 is a first perspective detail view of the tooling in FIG. 5;

FIG. 7 is a second perspective detail view of the tooling in FIG. 5;

FIG. 8 is a block diagram illustrating the steps of a first method for manufacturing a winding according to the invention;

FIG. 9 is a block diagram illustrating the steps of a second method for manufacturing a winding according to the invention;

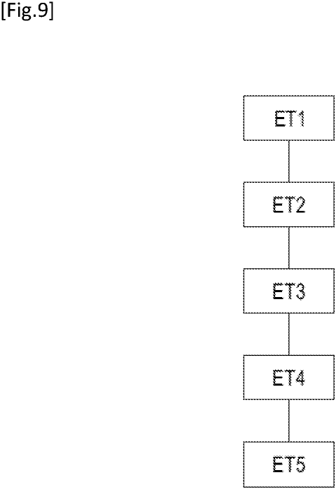

### DETAILED DESCRIPTION OF THE INVENTION

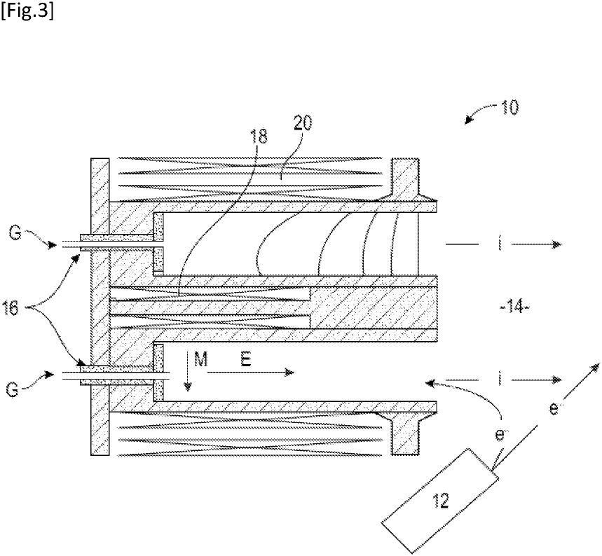

FIG. 3 shows a stationary plasma thruster 10 operating according to the hall-effect. In a known way, the operation of such a thruster is based on the principle consisting of ionising a neutral gas such as, for example, Xenon, Krypton, Bismuth, Argon, Iodine, Magnesium, or Zinc.

The resulting ions are accelerated by a strong axial electric field E which provides the impetus for the propulsion. In particular, the neutral gas G is injected into a hollow cathode 12 and into the discharge area 14 through an anode 16. The internal pressure in the hollow cathode 12 is a few hundred Pascals. At the outer opening of the thruster 10, i.e. in the discharge area 14, the neutral gas is ionised by electrons e- provided by the cathode 12.

The cathode 12 is initially heated to initiate the discharge. A voltage of the order of a few hundred volts, between 150 and 800 volts, is applied between the anode 16 and the cathode 12. The electrons from the cathode 12 ionise the neutral gas. The ions i are then accelerated by an axial electric field E between the anode 16 and the cathode 12. At the exit of the thruster, the ions i are neutralised by the cathode 18, which releases an equal amount of electrons e, creating a zero load plasma. A radial magnetic field M, perpendicular to the direction of discharge of the electric field E, of about 100 to 300 gauss (0.01-0.03 T) is used to confine the electrons, where the combination of the radial magnetic and axial electric fields results in the electrons being moved according to the Hall current, from which the name of the device is derived.

To form the radial magnetic field M, such a motor 10 uses two coaxial inductor windings 18, 20 inner and outer respectively.

These windings 18, 20 are subject to high thermal stresses and radiation and, in the case of the outer winding 20, to potential mechanical damage from micrometeorites to which the satellite carrying the motor 10 may be subjected.

Particular care must therefore be taken with the conductor forming these windings, as any loss of insulation between two turns of a winding would reduce the intensity of the magnetic field produced by it and alter the performance of the motor 10, or even lead to the end of life of the motor 10.

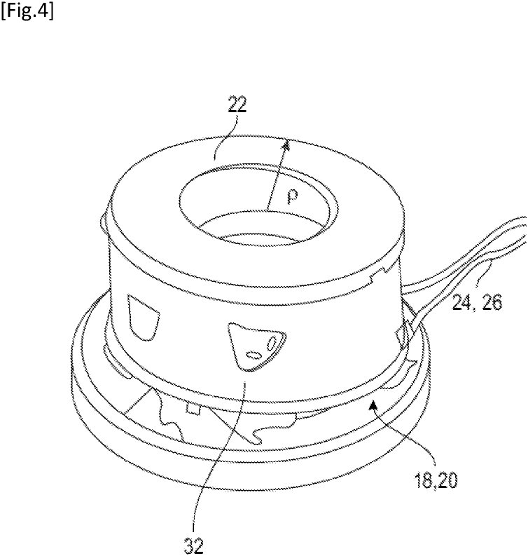

Generally speaking, a winding 18 or 20 comprises, as shown in FIG. 4, a nucleus 22 on which a conductor 24 is wound.

In accordance with the invention, in order to ensure an optimum protection of the conductor 24, the latter comprises an inorganic insulation cable 26 impregnated with a high-temperature resistant silicone coating.

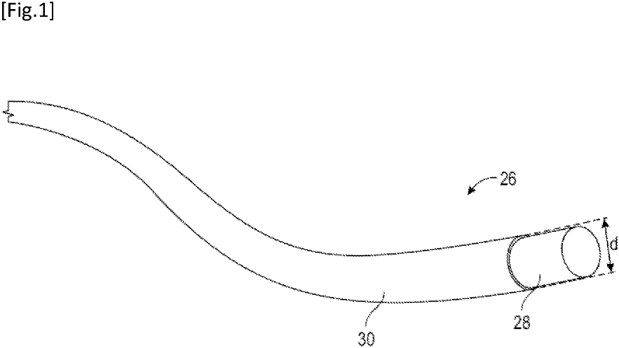

FIG. 1 shows a cable 26 with inorganic insulation. For example, the cable 26 comprises a copper-nickel alloy core 28 covered by a ceramic insulator 30. The cable 26 has a diameter d.

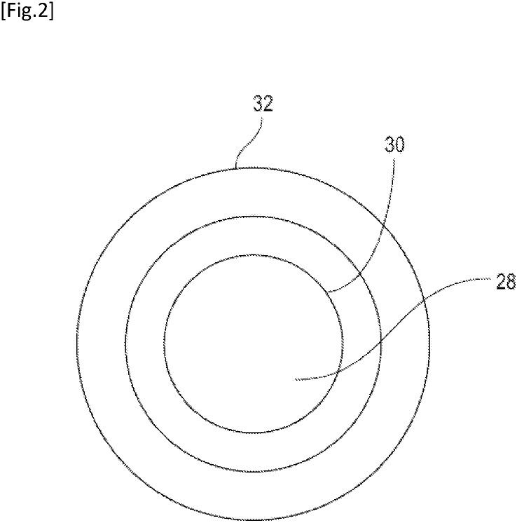

Such a ceramic insulator 30 offers excellent performance in terms of high temperature resistance. However, it is particularly rigid and brittle and can therefore be subject to cracking and flaking if exposed to excessive temperatures or impact. To this end, the invention advantageously proposes to impregnate the cable 26 with a silicone coating 32, as shown in FIG. 2.

Such a coating can withstand high temperatures of up to 593° C.

Advantageously, the silicone coating 32 is a coating deposited by soaking the cable 26 in a silicone compound dissolved in a solvent and then evaporating said solvent.

The silicone coating 32 is furthermore suitable for use at temperatures between -70° C. and 400° C., thus below the maximum permissible temperature of 593° C., is electrically insulating, has a drying temperature below 300° C., a thermal conductivity of more than 1W/m/°C and a coefficient of thermal expansion of more than 5.10-6/K.

To prevent the ceramic insulation layer 30 of the cable 26 from breaking when the cable 26 is wound around the nucleus 22, the nucleus 22 has a radius of curvature p, shown in FIG. 4, which is at least equal to at least five times a diameter d of the inorganic insulation cable 26.

The manufacture of an inductor winding 18, 20 can be carried out in two different ways. A first method is to impregnate the cable 26 as it is wound onto the nucleus 22. A second method is to wind the cable 26 onto the nucleus 22 and then impregnate the whole winding 18, 20 thus obtained.

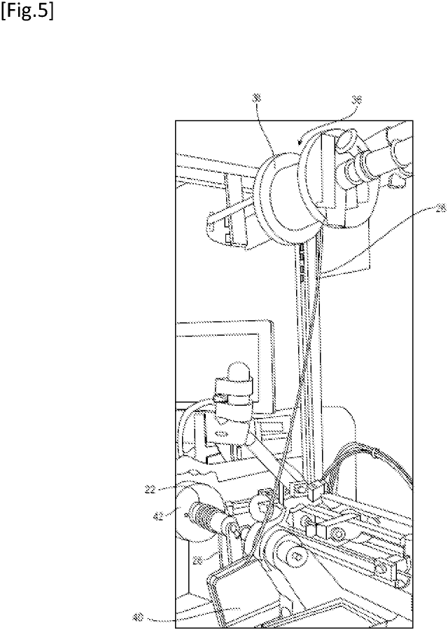

FIG. 5 shows a tooling 34 allowing to implement the first method.

This tooling 34 comprises a reel 36 that receives a coil 38 of the inorganic insulation cable 26. This reel 36 feeds with cable 26 an impregnation tray 40 containing the silicone compound dissolved in a solvent. The inorganic insulation cable 26 therefore runs through the reel 36. Then, the tooling 34 comprises a nucleus 22 of the winding, mounted in rotation on a mandrel 42, which is intended to receive in winding the cable 26 impregnated with silicone compound.

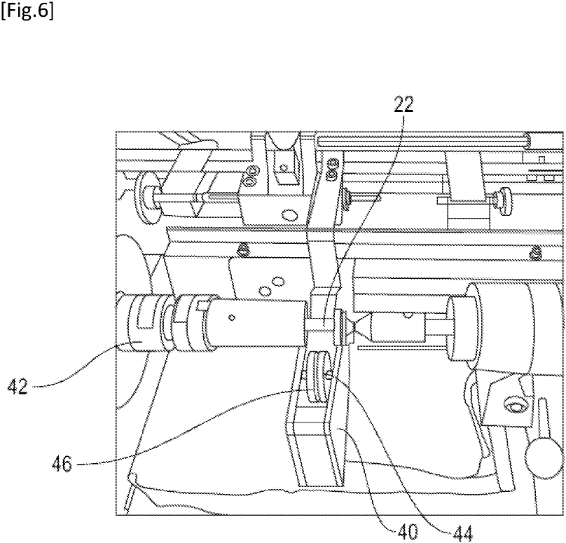

As illustrated in FIG. 6, the tray 40 comprises at least one caster 44 within the tray 40 which is configured to ensure the guidance of the insulated cable 26 as it passes through the tray 40. The caster 44 comprises a gorge 46 which is intended to allow the cable 26 to be guided.

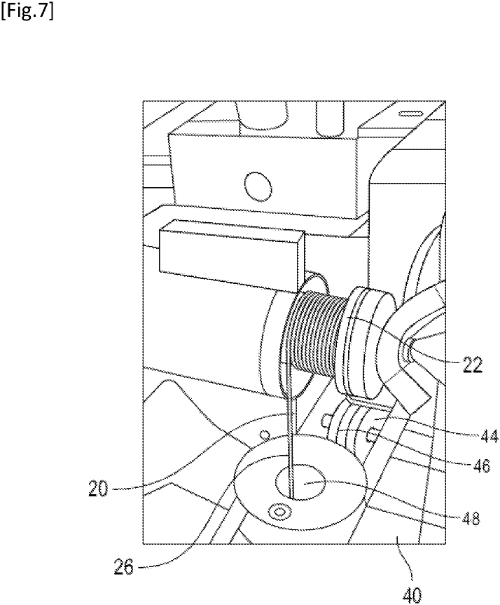

As illustrated in FIG. 7, the tray 40 may also comprise a sponge 48, placed at an outlet of the tray 40, which is passed through by the cable 26 to mop up the cable 26, in order to avoid excess silicone compound deposits on the cable 26.

It will be understood that all the rules relating to the use of the cable 26 apply both to its winding on the nucleus 22 and to its travel through the tooling 34. Therefore, during the winding of the cable 26, the path of the cable 26 in the tooling between the reel 36 and the nucleus 22 has radii of curvature which are all at least five times the diameter d of the inorganic insulation cable 26. Furthermore, these radii of curvature do not reverse between the reel 36 and the nucleus 22, so that there is no risk of damaging the ceramic insulator 30.

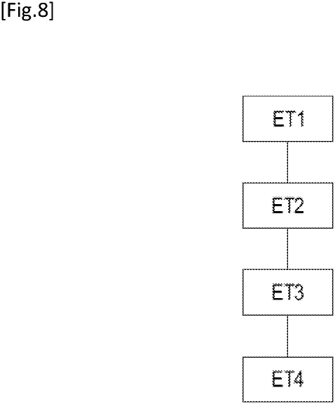

Thus, the first method for manufacturing the inductor winding 18, 20 comprises, as illustrated in FIG. 8, a first step ET1 of providing a nucleus 22 of the winding and placing this nucleus 22 in the mandrel 42 of the tooling 34.

Then, in a second step ET2, the inorganic insulation cable 26 is impregnated with the silicone compound by passing it through the tray 40 and it is wound onto the nucleus 22. The silicone coating 32 is deposited by soaking the cable 26 in the silicone compound dissolved in a solvent and then evaporating said solvent.

Then, in a third step ET3, the winding 18, 20 consisting of the nucleus 22 equipped with the impregnated cable 26 is left to dry at room temperature for several days.

Then, in a fourth step ET4, the winding 18, 20 is baked in an oven so as to vulcanize the silicone coating. This baking comprises a gradual rise in temperature to a baking temperature from room temperature, to avoid the bubbling of the silicone coating.

According to the second manufacturing method mentioned above, it similarly comprises a first step ET1 of providing the nucleus 22 of the winding 18, 20.

Then, in a second step ET2, the winding 18, 20 is produced by winding said inorganic insulation cable 26 directly onto the nucleus 22. This is followed by a third step ET3 in which the winding 18,20 is immersed in a bath of silicone compound dissolved in a solvent. The silicone coating 32 is deposited by soaking the winding 18, 20 in the silicone compound dissolved in a solvent and then by evaporating said solvent.

Then, in a fourth step ET4, the winding 18,20 is left to dry at room temperature for several days. Finally, during a fifth step ET5 of baking the winding in an oven, the winding 18 20 is baked in the same way as before, i.e. by carrying out a baking comprising a gradual rise in temperature up to a baking temperature starting from the ambient temperature.

The invention thus allows to produce a simple and efficient winding 18, 20 for a stationary plasma motor 10 used for the satellite positioning. The outer winding 20 may, for example, be additionally protected by a cover to protect it from micrometeorites.

1. An inductor winding for a plasma satellite motor operating according to the hall-effect, this inductor winding comprising a nucleus on which a conductor is wound, wherein this conductor comprises an inorganic insulation cable impregnated with a silicone coating resistant to high temperatures up to 593° C.

2. The inductor winding according to claim 1, wherein the inorganic insulation cable comprises a rigid core made of a copper-nickel alloy covered by a ceramic insulator.

3. The inductor winding according to claim 1, wherein the silicone coating is suitable for use at temperatures between -70° C. and 400° C., is electrically insulating, has a drying temperature below 300° C., a thermal conductivity above 1W/m/°C and a coefficient of thermal expansion above 5.10⁻⁶/K.

4. The inductor winding according to claim 1, wherein the nucleus (22) has a radius of curvature (ρ) greater than or equal to five times a diameter (d) of the inorganic insulation cable (26).

5. A tooling for the manufacture of an inductor winding according to claim 1, wherein it comprises:
a reel receiving a coil of the inorganic insulation cable;
an impregnation tray, receiving the silicone compound dissolved in a solvent, through which said inorganic insulation cable passes, and comprising at least one caster internal to the tray configured to ensure the guidance of said inorganic insulation cable as it passes through said tray and at least one sponge positioned at an outlet of said tray through which the cable passes to mop up said cable,
a nucleus of the winding mounted in rotation, for receiving in winding the cable impregnated with silicone compound and in that a path of said cable in said tooling between the reel and the nucleus has radii of curvature which are greater than or equal to five times a diameter (d) of the inorganic insulation cable and which do not reverse between the reel and the nucleus .

6. A method for manufacturing an inductor winding using a tooling according to claim 5, wherein it comprises at least:
a first step (ET1) of providing a nucleus of the winding and placing said nucleus in said tooling;
a second step (ET2) during which said inorganic insulation cable is impregnated with said silicone compound and during which it is wound onto the nucleus, the silicone coating being deposited when the cable is soaked in the silicone compound dissolved in a solvent and then by evaporation of said solvent,
a third step (ET3) during which the winding consisting of the nucleus equipped with the impregnated cable is left to dry at room temperature for several days,
a fourth step (ET4) of baking the winding in an oven, said baking comprising a gradual rise in temperature to a baking temperature starting from room temperature.

7. A method for manufacturing an inductor winding according to claim 1, wherein it comprises at least:
a first step (ET1) of providing a nucleus of the winding,
a second step (ET2) during which the winding is produced by winding said inorganic insulation cable on the nucleus,
a third step (ET3) during which said winding is immersed in a bath of silicone compound dissolved in a solvent, the silicone coating being deposited when the winding is soaked in the silicone compound dissolved in a solvent and then by evaporating said solvent,
a fourth step (ET4) during which the winding is left to dry at room temperature for several days,
a fifth step (ET5) of baking the winding in an oven, said baking comprising a gradual rise in temperature to a baking temperature starting from room temperature.

8. A plasma satellite motor operating according to the hall-effect, comprising at least one inductor winding according to claim 1.
